(19) United States
(12) Patent Application Publication
(10) Pub. No.: US 2006/0102177 A1
(43) Pub. Date: May 18, 2006

(54) Protective combination comprising face mask, protective hood, and elastomeric gasket attached to peripheral edge of protective hood

(75) Inventors: Patricia K. Lewis, Tipp City, OH (US); William L. Grilliot, Dayton, OH (US); Mary I. Grilliot, Dayton, OH (US)

Correspondence Address: WOOD, PHILLIPS, KATZ, CLARK & MORTIMER, 500 W. MADISON STREET, SUITE 3800, CHICAGO, IL, 60661, US

(73) Assignee: Morning Pride Manufacturing, L.L.C.

(21) Appl. No.: 10/991,056

(22) Filed: Nov. 17, 2004

(51) Int. Cl. A62B 17/04; A62B 7/10

(52) U.S. Cl. 128/201.23; 128/201.22; 128/201.25

(57) ABSTRACT

A protective combination wearable by a firefighter or by an emergency worker comprises a face mask, a fluid-impervious protective hood, and a fluid-impervious, elastomeric gasket. The face mask has a face-conformable gasket and a transparent window projecting from the face-conformable gasket. The protective hood has a peripheral edge, to which the elastomeric gasket is attached. The elastomeric gasket is adapted, when the protective combination is worn, to be tightly drawn against the face mask, along the face-conformable gasket, and to allow at least a substantial portion of the transparent window projecting from the face-conformable gasket to project through the elastomeric gasket. A preferred material for the elastomeric gasket is neoprene.

### TECHNICAL FIELD OF THE INVENTION

This invention pertains to a protective combination wearable by a firefighter or by an emergency worker and comprising a face mask, a protective hood, and, as provided by this invention,s an elastomeric gasket, which is used to draw a peripheral edge of the protective hood tightly against the face mask.

### BACKGROUND OF THE INVENTION

Commonly, when called upon to deal with hazardous chemical or biological materials, a firefighter or an emergency worker wears a face mask, which is connected to a self-contained breathing apparatus (SCBA) or to a respirator having an air filter, and a protective garment, such as protective coveralls, which has a hood. It has been known, heretofore, to use fluid-tight tape to form a fluid-tight seal between the face mask and the hood.

Commonly, a face mask to be thus worn has a transparent window and a rubbery, face-conformable gasket around the transparent window. Commonly, the rubbery, face-conforming gasket has an outwardly opening trough, which bounds the transparent window. Such a face mask having such a gasket having such a trough is available commercially from numerous sources.

As disclosed in U.S. Pat. No. 6,775,850 B1, the disclosure of which is incorporated herein by reference, an inflatable tube is provided, which is adapted to form a fluid-tight seal between the face mask and the hood, when the inflatable tube is inflated so as to press the peripheral edge of the hood into the outwardly opening trough, whereby to provide a seal between the face mask and the hood. As disclosed therein, the face mask has a face-conformable gasket, which has the outwardly opening trough, and the peripheral edge of the hood has a tubular hem, through which the inflatable tube extends.

### SUMMARY OF THE INVENTION

This invention provides a protective combination wearable by a firefighter or by an emergency worker and comprising a face mask, which has a transparent window, a protective hood, which has a peripheral edge, and an elastomeric gasket, which is attached to the peripheral edge of the protective hood, and which is adapted, when the protective combination is worn, to be tightly drawn against the face mask and to allow at least a substantial portion of the transparent window to project through the elastomeric gasket.

In a preferred embodiment, wherein the face mask has a face-conformable gasket and a transparent window projecting from the face-conformable gasket, the elastomeric gasket is adapted, when the protective combination is worn, to be tightly drawn against the face mask, along the face-conformable gasket, and to allow at least a substantial portion of the transparent window projecting from the face-conformable gasket to project through the elastomeric gasket. A preferred material for the elastomeric gasket is neoprene.

### BRIEF DESCRIPTION OF THE DRAWINGS

FIG. 1 is a fragmentary perspective view of a person, such as a firefighter or an emergency worker, who is wearing a protective combination comprising a face mask, a protective hood, and an elastomeric gasket and embodying this invention.

FIG. 2 is a fragmentary, sectional view taken along line 2-2 of FIG. 1, in a direction indicated by arrows.

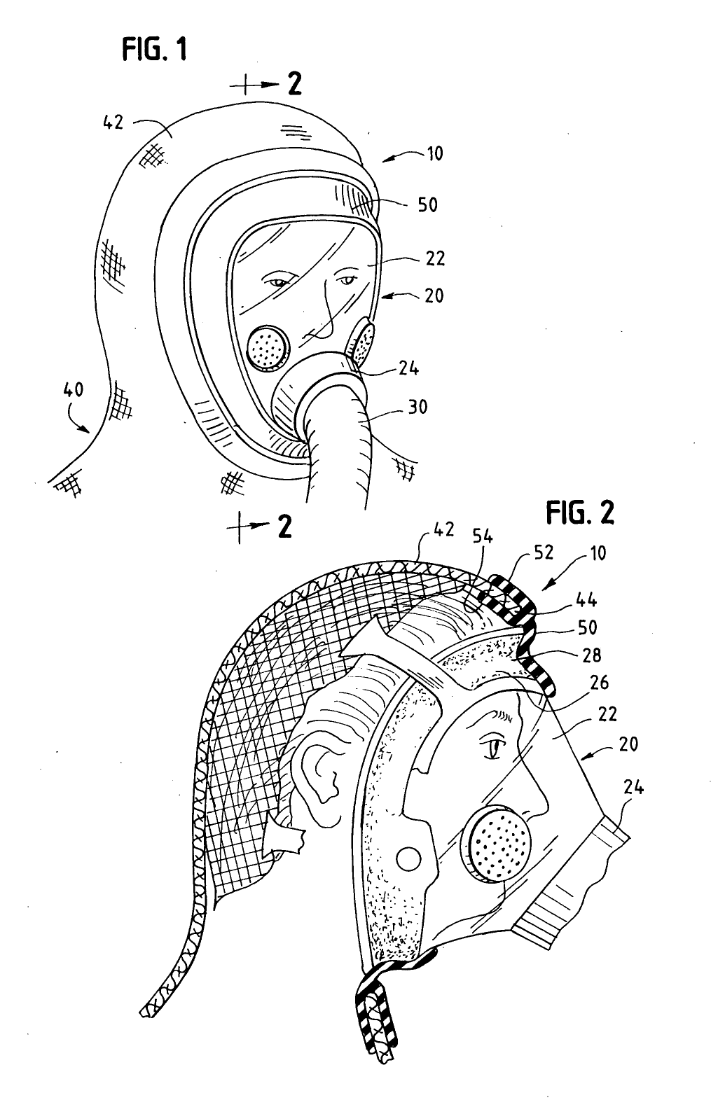

### DETAILED DESCRIPTION OF THE ILLUSTRATED EMBODIMENT

As illustrated, a protective combination 10 worn by a firefighter or by an emergency worker comprises a face mask 20, which is connected to a self-contained breathing apparatus (SCBA) via flexible hose 30, a protective garment 40, which has a fluid-impervious, protective hood 42 having a peripheral edge 44, and, as provided by this invention, a fuid-impervious, elastomeric gasket 50, which provides a fluid-impervious seal between the face mask 20 and the protective hood 42.

As illustrated, the face mask 20 has a transparent window 22, a fitment 24, by which the flexible hose 32 is connected to the face mask 20, at the transparent window 22, and a rubbery, face-conformable gasket 26, which bounds the transparent window 22 and which defines an outwardly opening trough 28. Except as illustrated and described herein, details of the face mask 20 are outside the scope of this invention and can be readily supplied by a person having ordinary skill in the art.

The protective garment 40 is made from sheets of fluid-impervious films, fabrics, or laminates. Similar protective garments are exemplified in U.S. Pat. No. 4,272,851, No. 4,864,654, and No. 6,364,980, which disclose suitable films, fabrics, and laminates and the disclosures of which are incorporated herein by reference. Except as illustrated and described herein, details of the protective garment 40 are outside the scope of this invention and can be readily supplied by a person having ordinary skill in the art.

As illustrated, the elastomeric gasket 50 has an outer flange 52 overlying the peripheral edge 44 of the protective hood 40 and an inner flange 54 underlying the peripheral edge 44 of the protective hood 40 and is attached via the outer and inner flanges 52, 54, to the peripheral edge 44 of the protective hood 42, either adhesively or via stitches that are sealed so as to be fluid-impervious. A preferred material for the elastomeric gasket 50 is neoprene.

Thus, the elastomeric gasket 50 is adapted, when the protective combination 10 is worn, to be tightly drawn against the face mask 20, along the outwardly opening trough 28 defined by the face-conformable gasket 26, and to allow at least a substantial portion of the transparent window 22, which projects outwardly from the face-conformable gasket 26, to project outwardly through the elastomeric gasket 50. Moreover, since the elastomeric gasket 50 is fluid-impervious, the elastomeric gasket 50 provides a fluid-impervious seal between the face mask 20 and the protective hood 40.

1-5. (canceled)

6. A protective combination wearable by a firefighter or by an emergency worker, the protective combination comprising a face mask, which has a face-conformable gasket defining a trough, a protective hood, which has a peripheral edge, and an elastomeric gasket, which is attached directly to the peripheral edge of the protective hood, and which is adapted, when the protective combination is worn, to be tightly drawn against the face mask, along the trough defined by the face-conformable gasket.

8. The protective combination of claim 6, wherein the face mask has a transparent window, which projects through the face-conformable gasket and which is adapted, when the protective combination is worn, to project through the elastomeric gasket drawn tightly against the trough defined by the face-conformable gasket.
